(19) United States
(12) Patent Application Publication
(10) Pub. No.: US 2025/0039779 A1
(43) Pub. Date: Jan. 30, 2025

(54) HANDOVER TECHNOLOGY FOR SLICE BASED NETWORK SELECTION

(71) Applicant: Apple Inc., Cupertino, CA (US)

(72) Inventors: Vivek G. Gupta, San Jose, CA (US); Anikethan Ramakrishna Vijaya Kumar, Mysuru (IN); Basant Kumar, Bangalore (IN); Nirlesh Koshta, Bangalore (IN); Shashanka Totadamane Ramappa, Shivamogga (IN); Sridhar Prakasam, Fremont, CA (US)

(73) Assignee: Apple Inc., Cupertino, CA (US)

(21) Appl. No.: 18/759,327

(22) Filed: Jun. 28, 2024

Related U.S. Application Data
(60) Provisional application No. 63/529,626, filed on Jul. 28, 2023.

(51) Int. Cl. H04W 48/18; H04W 8/12; H04W 60/00; H04W 84/04

(52) U.S. Cl. CPC H04W 48/18; H04W 8/12; H04W 60/00; H04W 84/042

(57) ABSTRACT

Techniques are described for slice based public land mobile network selection. An example method includes a network node of a home public land mobile network (HPLMN) transmitting configuration information to a user equipment (UE) to configure the UE to receive enhanced slice-based steering of roaming (SoR) information during a registration process with a visited public land mobile network (VPLMN). The method further includes the network node determining that the UE is registering with the VPLMN. The method further includes the network node transmitting the enhanced slice-based SoR information to the UE based on the determination that the UE is registering with the VPLMN.

### CROSS-REFERENCES TO RELATED APPLICATIONS

This application claims the benefit of U.S. Provisional Application No. 63/529,626, filed on Jul. 28, 2023, which is incorporated by reference.

### BACKGROUND OF THE INVENTION

Cellular communications can be defined in various standards to enable communications between a user equipment and a cellular network. For example, a long-term evolution (LTE) network and Fifth generation mobile network (5G) are wireless standards that aim to improve upon data transmission speed, reliability, availability, and more.

### BRIEF DESCRIPTION OF THE DRAWINGS

FIG. 1 is an illustration of a system slice selection, according to one or more embodiments.

FIG. 2 is a signaling diagram for sending UE assistance information, according to one or more embodiments.

FIG. 3 is a list of priority public land mobile network (PLMN) identifiers and supported slices, according to one or more embodiments.

FIG. 4 is a list of PLMNs, according to one or more embodiments.

FIG. 5 is a list of priority PLMN identifiers and supported slices, according to one or more embodiments.

FIG. 6 is a table of use cases for slice-based PLMN selection, according to one or more embodiments.

FIG. 7 is a process flow for slice-based PLMN selection, according to one or more embodiments.

FIG. 8 is a process flow for slice-based PLMN selection, according to one or more embodiments.

FIG. 9 is a process flow for slice-based PLMN selection, according to one or more embodiments.

FIG. 10 is a process flow for slice-based PLMN selection, according to one or more embodiments.

FIG. 11 illustrates an example of receive components, in accordance with some embodiments.

FIG. 12 illustrates an example of a user equipment (UE), in accordance with some embodiments.

FIG. 13 illustrates an example of a network node, in accordance with some embodiments.

### DETAILED DESCRIPTION OF THE INVENTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, 5G NR, or 6G. In general, 3GPP access refers to various types of cellular access technologies.

The term “Non-3GPP Access” refers to any accesses (e.g., radio access technologies) that are not specified by 3GPP standards. These accesses include, but are not limited to, WiMAX, CDMA2000, Wi-Fi, WLAN, or fixed networks. Non-3GPP accesses may be split into two categories, “trusted” and “untrusted.” Trusted non-3GPP accesses can interact directly with an evolved packet core (EPC) or a 5G core (5GC), whereas untrusted non-3GPP accesses interwork with the EPC/5GC via a network entity, such as an Evolved Packet Data Gateway or a 5G NR gateway. In general, non-3GPP access refers to various types on non-cellular access technologies.

The 3GPP Technical Specification Group and System Aspects Working Group 1 (SA1) introduced a new requirement as part of the Enhanced Access to and Support of Network Slice (EASNS) study in Release-18, SA1 introduced a requirement: For a roaming user equipment (UE) activating a service/application requiring a network slice not offered by the serving network but available in the area from other network(s), the home public land mobile network (HPLMN) shall be able to provide the UE with prioritization information of the visiting public land mobile networks (VPLMNs) with which the UE may register for the network slice (3GPP Technical Specification (TS) 22.261 V18.10.0 (2023-06-23)).

3GPP Technical Specification Group and System Architecture Working Group 2 (SA2) studied the above requirements and issued 3GPP Technical Report (TR) 23.700-41 V18.0.0 (2022-02). In some instances, stage 2 enables HPLMN to provide UE with a preferred list of PLMNs for each network slice based on UE subscription, and UE performs the PLMN selection based on the received information. The HPLMN can update this information subsequently upon change in UE subscription or based on other HPLMN triggers.

SA2 has not defined UE behavior on receiving this information, and there are several aspects of overall PLMN selection that can receive more clarity. One missing aspect of the SA2 solution is that it does not go into the details of how enhanced slice-aware information interacts with legacy prioritized PLMN lists for PLMN selection. Furthermore, there is a need to resolve a conflict when the UE wants to use more than one slice, and there is conflicting enhanced slice-aware information for each slice. This conflict can arise when the UE is interested in multiple slices and the higher priority slice that the UE is interested in is offered by a lower priority VPLMN. Therefore, should the UE prioritize slice or the PLMN in this situation. If the user/UE prioritization of slices is not considered, the UE could end up being denied the most desired slice/service by selecting a PLMN that does not provide that slice/service but provides another “subscribed” slice for this UE.

Embodiments herein provide techniques to assist a selection process for a UE that intends to use multiple slices that are provided by different VPLMNs and avoid selecting, discarding and then re-selecting (e.g., ping-ponging) between VPLMNs.

Embodiments describe the granularity of the information provided to the UE, such that UE can select an available PLMN with the highest priority single-network slice selection assistance information (S-NSSAI). For example, for S-NSSAI-1, PLMN-1 may be the highest priority PLMN. However, for PLMN-1 some pockets (e.g., tracking areas (TAs)) may not support S-NSSAI-1 at a given location of the UE. This can occur, for example, for a partially rejected S-NSSAI or a partially allowed S-NSSAI. Embodiments describe how to assist the UE to select a PLMN in this situation while avoiding ping-ponging across PLMNs with varying slice coverage.

In some instances, a user can use their UE to launch different applications that select different slices. Various aspects of this disclosure can assist the UE in the VPLMN selection process in these instances. The aspects can further assist with determining how a PLMN search is triggered while taking slice preference into account. Furthermore, UE can use the described aspects to minimize frequent and unnecessary PLMN searches and avoid ping-ponging across different VPLMNs, while taking into account different triggers for PLMN selection. The aspects can further be used to assist a UE on legacy network (e.g., evolved packet system (EPS)/4G/3G/2G) and during Inter Radio Access Technology (IRAT) and inter-subsystem transitions with varying radio coverage and avoid ping-ponging across different VPLMNs.

In current network environments, an HPLMN can provide a roaming UE with steering of roaming (SoR) information that provides a list of preferred PLMN and access technology combinations. The HPLMN may use proprietary solutions or over-the-air (OTA) over short message service mobile terminated (SMS MT). This information may not be secure end to end, and a VPLMN may alter the information. Additionally, not all devices support SMS. Still, a roaming UE can select a PLMN to camp on based on the list of preferred PLMN and access technology combinations. However, current PLMN selection strategies do not take into account network slicing. Rather, network slices are selected after the UE has registered with a PLMN.

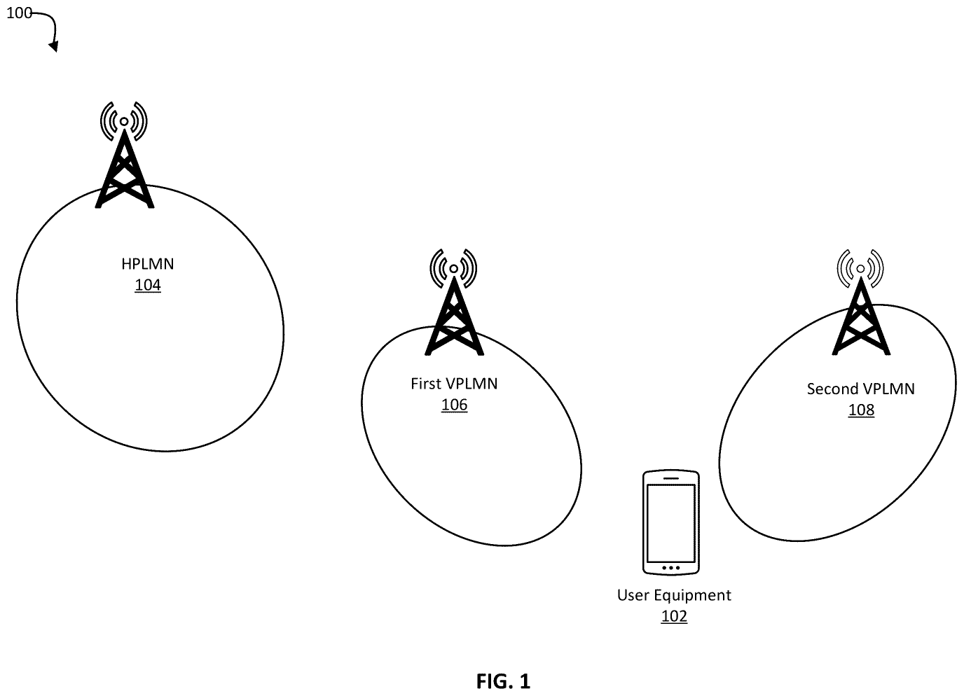

FIG. 1 is an illustration of a network environment 100 in which a system slice selection may occur, according to one or more embodiments. A UE 102 can have a subscription with an operator that provides an HPLMN 104, which includes a coverage area for providing wireless services to the UE 102. From time to time, a user may leave the coverage and disconnect from the HPLMN 104 and connect with a visiting public land mobile network (VPLMN). As described herein, the UE 102 can use enhanced slice information to select a VPLMN (e.g., a first VPLMN 106 or a second VPLMN 108). The HPLMN 104 can configure subscribed UEs to indicate that the UE can be expected to receive enhanced slice-based steering of roaming information (SoR) information (ESI) as part of an initial registration with a VPLMN. The HPLMN 104 can also indicate the ESI in the subscription information in the unified data management (UDM). The HPLMN 104 can provide UE 102 with the ESI based on various factors. For example, the HPLMN 104 can provide the ESI based on a set of slices in the UE's subscribed NSSAI, roaming agreements, slice deployed in the UE's current location, UE assistance information, slice location, and time validity. The UE 102 may not be in a position to transmit information regarding applications running on the UE 102 during a VPLMN registration process for the purpose of PLMN selection based on network slice. However, the UE 102 can transmit a list of S-NSSAI(s) that the UE 102 is interested in as part of the UE assistance information provided during the registration process.

In the event that the UE 102 is interested in multiple applications/services, the UE 102 can be configured to determine a priority order of the applications/services, and any corresponding network slices. Thus, UE 102 can be configured to have a priority order for these corresponding network slices based on, for example, the UE type, UE's user preferences, a UE subscription, or other appropriate considerations. In other cases, the UE can select a subset of slices (based on implementation, local configuration or user input) from the ones that it is interested to select the most appropriate VPLMN. The subset can include one or more slices.

If the ESI is updated after the UE 102 has registered with a VPLMN, the HPLMN 104 can provide the UE 102 with the updated ESI through the VPLMN with which the UE 102 is registered. For example, the HPLMN 104 can provide an updated ESI based on a change in roaming agreement, the availability of network slices, and a change in UE assistance information. It should be appreciated that the HPLMN 104 can transmit ESI information, including updated ESI information, to the UE 102 if the UE 102 is registered with a pre-3GPP release 18 network, as well as a 3GPP release 18 network.

If the UE 102 receives ESI, the UE 102 can be configured to select a highest priority slice, or set of slices, based on the UE's local prioritization. The UE 102 can then use a list of VPLMNs provided in the ESI to select a highest priority VPLMN (e.g., the first VPLMN 106 or the second VPLMN 108) that can support the highest priority slice.

In some embodiments, the UE 102 can be configured to begin searching for a higher priority VPLMN when the UE 102 has received the list of VPLMNs and the UE's application processor (AP) has requested to activate an S-NSSAI of the VPLMN with which it is registered and the S-NSSAI is not in the allowed NSSAI. In some embodiments, the UE 102 can start a timer (e.g., a higher priority public land mobile network (HPPLMN) timer), and stay on a selected VPLMN (e.g., the first VPLMN 106 or the second VPLMN 108) until the expiration of the timer. Upon the expiration of the timer, the UE 102 can start a PLMN selection based on network slices to determine whether to switch to another VPLMN.

During the registration process with the VPLMN, the UE can activate any slice (S-NSSAI) that has been provided in the configured NSSAI. The configured NSSAI can either be configured by a registered PLMN (e.g., the first VPLMN 106 or the second VPLMN 108) and apply to the registered PLMN, or may be a default configured NSSAI configured by the HPLMN 104 and that applies to any PLMNs (e.g., the first VPLMN 106 or the second VPLMN 108), for which no specific configured NSSAI has been provided to the UE 102. For example, the UE 102 can activate the slice in the REGISTRATION ACCEPT message or CONFIGURATION UPDATE COMMAND message.

The trigger for the UE 102 to activate a slice can be executed by any application that has started to run on the UE's AP or is running on the UE's AP. In some instances, the trigger can be initiated by a UE user, and in other instances, the trigger can be initiated by the application.

PLMN selection based on network slices according to various aspects of this disclosure can result in less ping-ponging between VPLMNs. The herein described PLMN selection based on network slices can also result in less scanning for VPLMNs, which in turn conserves battery life. The herein-described PLMN selection based on network slices is efficient, does not deteriorate the user experience, and is cost effective in that it can reduce roaming charges. Furthermore, the home network can steer the UEs to perform dynamic load balancing on network resources.

The HPLMN 104 can use OTA signaling to configure the UE's universal subscriber identity module (USIM) to indicate that the UE 102 is expected to receive the “ESI” due to initial registration in a VPLMN. The HPLMN 104 can also indicate that the UE 102 is expected to receive the “ESI” due to initial registration in a VPLMN, in the subscription information in the UDM.

In some instances, the USIM of the UE 102 may be configured to receive both the ESI and SoR information. In these instances, various outcomes are possible. For example, the HPLMN 104 can send both the ESI and the SoR information to the UE 102. In this situation, the UE 102 can use the ESI and not consider SoR information.

In another example, the HPLMN 104 can send whichever of the ESI or the SoR information that has been updated to the UE 102. The HPLMN 104 can further transmit an indication that the other list has not been updated. The UE 102 can use whichever of the ESI or the SoR information that it has received.

In another example, the HPLMN 104 can send whichever of the ESI or the SoR information that has been updated to the UE 102. The UE 102 can use whichever of the ESI or the SoR information that it has received. The UE 102 can further be configured to assume that the other of the ESI or the SoR information that was not received has not been updated without an explicit indication of no update. The UE 102 can further be configured to determine that an error has not occurred due to not receiving both the ESI and the SoR information.

In another example, if neither of the ESI or the SoR information have been updated, the HPLMN 104 can transmit an indication that neither list has been updated. In particular, the HPLMN 104 can transmit a “no change needed” message. The UE 102 can further be configured to determine that an error has not occurred due to not receiving both the ESI and the SoR information.

In another example, if the UE 102 does not receive either the ESI or the SoR information, the UE 102 can be configured to determine that there is an erroneous situation. The UE 102 can further be configured to deprioritize the current VPLMN and VPLMN selection can be handled as per current handling for SoR information.

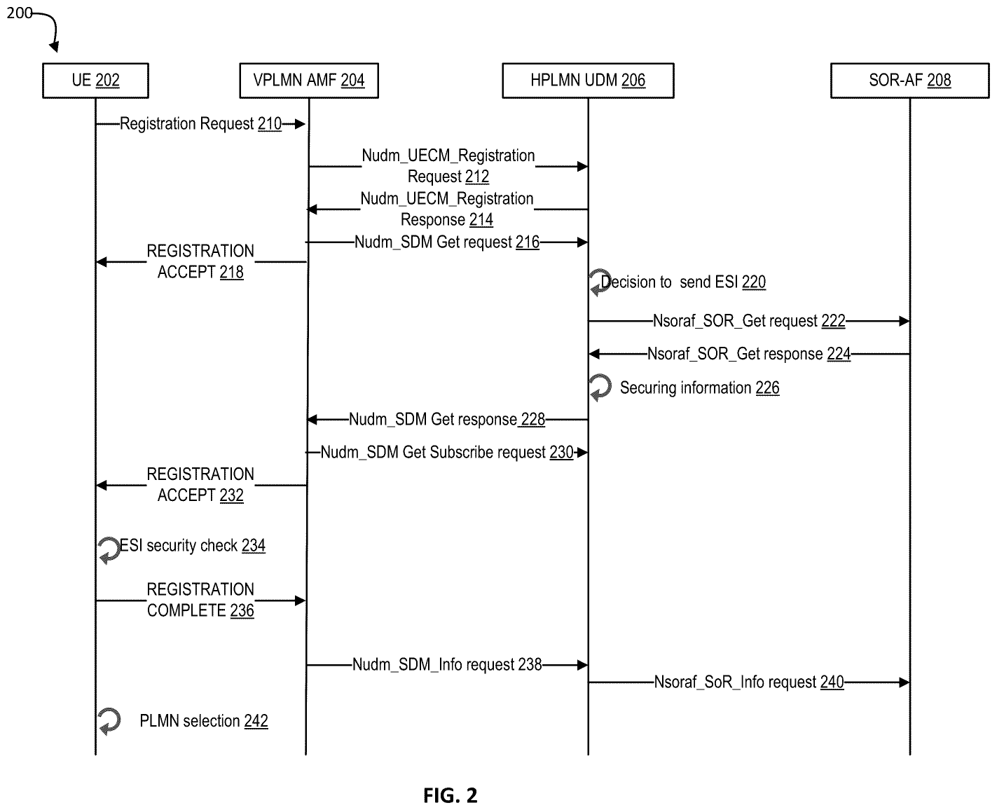

FIG. 2 is a signaling diagram 200 for sending UE assistance information, according to one or more embodiments. As illustrated, a UE 202 can be in communication with a VPLMN Access & Mobility Function (AMF) 204, an HPLMN UDM 206, and an SoR application function (AF) 208. At 210, the UE 202 can transmit a REGISTRATION REQUEST message to the VPLMN AMF 204. The REGISTRATION REQUEST message can include assistance information in an SoR-transparent container. The UE assistance information can include a list of S-NSSAIs in order of priority. For example, each S-NSSAI can be associated with a ranking. The list of S-NSSAI(s) can include all the configured NSSAI(s) of the current registered PLMN or the list can include a subset of S-NSSAI(s) that the UE 202 is currently requesting access for in either the REGISTRATION REQUEST message or in the UPLINK NAS TRANSPORT message. Each time that the UE 202 transmits UE assistance information, the UE 202 can be configured to expect an acknowledgement, which may be mandatory in some instances, from the HPLMN via SoR transparent container. The UE 202 can receive the acknowledgement along with the ESI or an indication by HPLMN, via SoR transparent container, that there is no change/update in the ESI. The acknowledgement by HPLMN in the SoR transparent container can indicate that the HPLMN UDM 206 has received the UE assistance information.

The UE 202 can trigger a registration procedure with the VPLMN each time that the UE 202 desires to transmit assistance information to the HPLMN. At 212, the VPLMN AMF 204 can transmit a UDM interface UE connection management registration request (Nudm_UECM_Registration) Request message to indicate the assistance information to the HPLMN UDM 206. The Nudm_UECM_Registration Request message can include a request as to whether the UE 202 is subscribed to receive ESI.

The VPLMN AMF 204 can execute the registration procedure, including executing primary authentication of the UE 202 and then initiate a non-access stratum (NAS) security, mode, command (SMC) procedure, after the authentication is successful. At 214, the HPLMN UDM 206 can transmit an Nudm_UECM_Registration Response message in an SoR transparent container to the VPLMN AMF 204. The Nudm_UECM_Registration Response message can include information for the UE 202, including an acknowledgment of receipt of the assistance information. The Nudm_UECM_Registration Response message can further include an indication as to whether the UE 202 has the capability to receive ESI.

If the UE 202 is indicated to have the capability to receive ESI, the VPLMN AMF 204 can transmit a Nudm subscriber data management Get (Nudm_SDM Get) request for the ESI to the HPLMN UDM 206 at 216. If the UE 202 is indicated to not have the capability to receive ESI, the VPLMN AMF can transmit a REGISTRATION ACCEPT message to the UE 202 at 218. The VPLMN AMF 204 can transmit the SoR information along with the REGISTRATION ACCEPT MESSAGE at 218. From 218, the process can proceed to 234.

If the UE 202 is indicated to have the capability to receive ESI, the HPLMN UDM 206 can decide to transmit the ESI to the UE 202 at 220. At 222, the HPLMN UDM 206 can transmit a SoR AF interface (Nsoraf-SoR) get request to the SoR-AF 208. The Nsoraf-SoR_Get request can include the assistance information provided by the UE.

At 224, the SoR-AF 208 can transmit a Nsoraf-SoR_Get response to the HPLMN UDM 206. The Nsoraf-SoR_Get response can include the ESI or an indication that the ESI has not been updated. The SoR-AF 208 can also transmit an acknowledgement of receiving the UE assistance information. The SoR-AF 208 can further store an information element (IE), such as a SoR-message authentication code (MAC)-1UE. The SoR-AF 208 can further expect to receive the same IE back from the HPLMN UDF 206.

At 226, the HPLMN UDM 206 can invoke secure protection service operation. At 228, the HPLMN UDM 206 can transmit a Nudm_SDM_Get response message to the VPLMN AMF 204. The Nudm_SDM_Get response message can include the ESI and the acknowledgment of receipt of the UE assistance information. At 230, the VPLMN can transmit a Nudm_SDM_Subscribe request message to the HPLMN UDM 206 to request notification of any changes in the Access and Mobility subscriber information.

At 232, the VPLMN AMF 204 can transmit a REGISTRATION ACCEPT message to the UE 202. The VPLMN AMF 204 can transmit can also transmit one or more of the ESI, an indication that the ESI has not been updated, the SoR information, or an indication that the SoR information has not been updated. The VPLMN AMF 204 can transmit can also transmit the acknowledgment of receipt of UE assistance information from the HPLMN UDM 206 or the SoR-AF 208. The VPLMN AMF 204 can further transmit an acknowledgment that the UE 202 has the capability to receive ESI.

From 218 or from 232, the process can proceed to 234. At 234, the UE 202 can perform a security check on the information received at 218 or 232. If the UE 202 had transmitted assistance information, the UE can, in particular, determine whether the information includes the acknowledgment of receipt of UE assistance information from the HPLMN UDM 206 or the SoR-AF 208. The security check can further include determining whether the information includes an acknowledgment that the UE has the capability to receive ESI.

If the UE 202 can successfully perform the security check of the information, then the UE 202 can transmit the REGISTRATION COMPLETE message at 236. In some instances, the VPLMN AMF 204 can include a request for acknowledgment of receipt of ESI from the UE 202. In these instances, the UE can transmit the acknowledgment in the REGISTRATION COMPLETE message.

If, however, the UE 202 determines the security check on the information received from the HPLMN UDM 206 fails, then the UE 202 can transmit a REGISTRATION COMPLETE message to indicate that the UE 202 is to deprioritize the VPLMN and use any pre-existing ESI or SoR list to register with another VPLMN. Alternatively, the UE 202 might choose to attempt registration with UE assistance information for a predefined set of attempts and upon missing SoR information in all these attempts, may choose to deprioritize the current PLMN. Additionally, the network might request for acknowledgement of reception of SoR information from the UE 202, which the UE 202 in turn can send in the REGISTRATION COMPLETE message.

At 238, the VPLMN AMF 204 can transmit a Nudm_SDM_Info Request message to the HPLMN UDM 206. The Nudm_SDM_Info Request message can include an IE, such as the same IE stored by the SoR-AF 208 at 224.

At 240, the HPLMN UDM 206 can transmit a Nudm_SDM_Info Request message to the SoR-AF 208. The Nudm_SDM_Info Request message can include an IE, such as the same IE stored by the SoR-AF 208 at 224.

At 242, the SoR-AF 208 can perform a security check by comparing the IE received from the HPLMN UDM 206 with the IE stored at 224.

At 244, the UE 202 can search for a VPLMN to register with based on the ESI or the SoR information.

It can be contemplated that a pre 3GPP Release-18 network may not necessarily be upgraded to support ESI. In this instance, if the UE 202 is configured, by subscription, to receive ESI and if the HPLMN needs to query UE assistance information, then as part of the UE's registration on VPLMN, when the VPLMN AMF 204 communicates with HPLMN UDM 206, the HPLMN UDM 206 can transmit a REGISTRATION ACCEPT message with an indication to the UE 202 in a SoR transparent container that requests the UE assistance information. The UE 202, upon receiving this indication in the SoR transparent container, can transmit the UE assistance information in an SoR transparent container along with a REGISTRATION COMPLETE message. The VPLMN AMF 204 can forward this SoR container to the HPLMN UDM 206. The HPLMN UDM 206 can then indicate to VPLMN to send the SoR-transparent container with ESI, which in turn will result in the VPLMN AMF 204 passing on this to the UE 202 in a downlink (DL) NAS transport message.

In some instances, the HPLMN may have requested for an acknowledgment for the ESI or SoR information. In these instances, the UE 202 can send an acknowledgment indicating receipt of ESI, assuming the security check of the information and decoding was successful. If the security check was unsuccessful, the UE 202 can deduce this as an error condition and shall deprioritize the current PLMN and attempt PLMN selection based on the existing lists that it has.

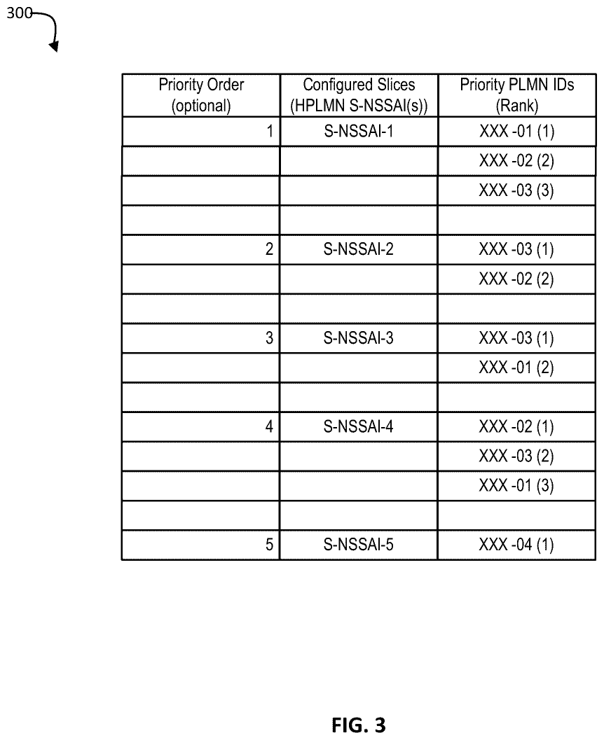

FIG. 3 is a list 300 of priority PLMN identifiers and supported slices, according to one or more embodiments. The list 300 is illustrated in table format and includes an optional priority order column, a configured slices column, and a priority PLMN identifiers (IDs) column. As illustrated, the list includes five configured slices, S-NSSAI-1, S-NSSAI-2, S-NSSAI-3, S-NSSAI-4, and S-NSSAI-5. Furthermore, there are identifiers for four PLMNs listed, XXX-01, XXX-02, XXX-03, and XXX-04.

The Priority PLMN IDs (Rank) column in the list 300 indicates which PLMN supports which configured slice. For example, configured slice S-NSSAI-1 is supported by PLMNs identified as XXX-01, XXX-02, and XXX-03. Additionally, configured slice S-NSSAI-2 is supported by PLMNs identified as XXX-03 and XXX-02. In addition to indicating which PLMNs support which configured slices, the list 300 indicates a ranking each PLMN based on the configured slice. For example, for S-NSSAI-1, the XXX-01 is the identifier for the highest ranked PLMN, then XXX-02 is identifier for the second highest ranked PLMN, and XXX-03 is the identifier for the third highest ranked PLMN.

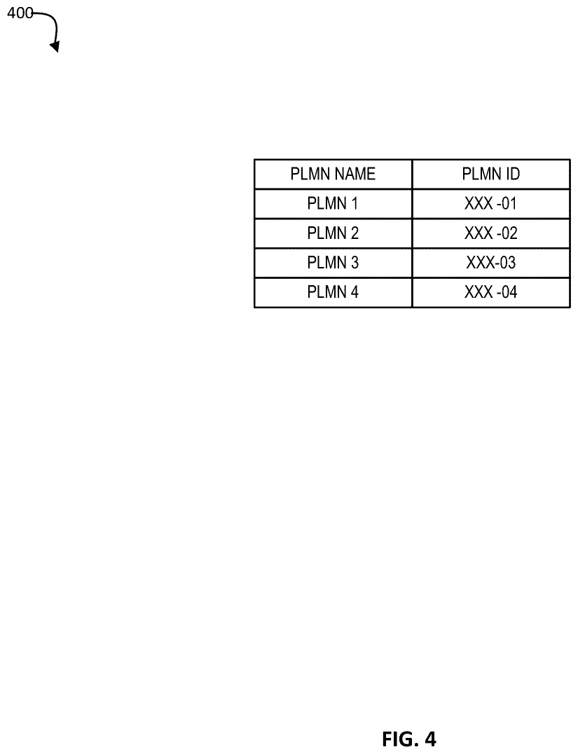

FIG. 4 is a list 400 of PLMNs, according to one or more embodiments. As illustrated, each PLMN ID from list 300 corresponds to a PLMN name. For example, XXX-01 corresponds to PLMN 1.

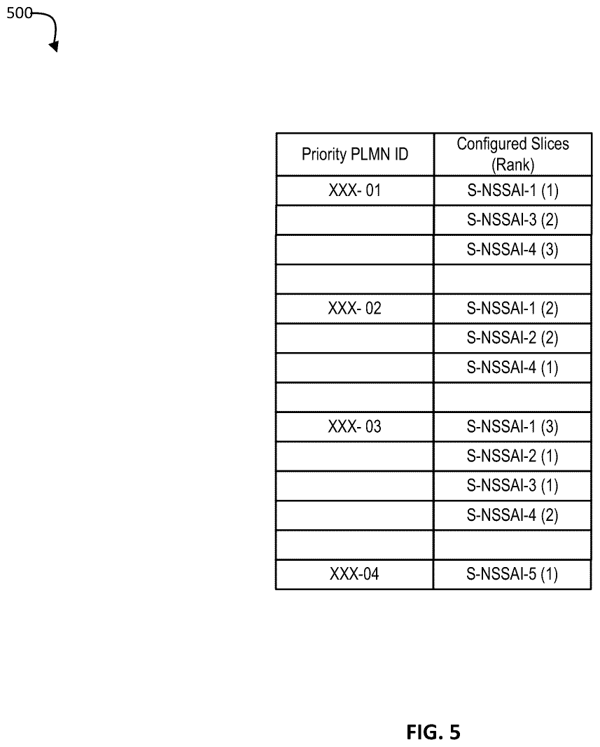

FIG. 5 is a list 500 of priority PLMN identifiers and supported slices, according to one or more embodiments. The list 500 includes a Priority PLMN IDs column and a configured slices column. Each PLMN identifier is illustrated as corresponding to configured slices. For example, XXX-01 corresponds to S-NSSAI-1, S-NSSAI-3, S-NSSAI-4. In other words, XXX-01 supports these three configured slices. In addition, the configured slice column indicates the ranking of each of these configured slices with respect to the corresponding PLMN ID. For XXX-01, S-NSSAI-1 is the highest ranked configured slice, S-NSSAI-3 is the second highest ranked configured slice, and S-NSSAI-4 is the third highest ranked configured slice. One or more of the lists described in FIGS. 3, 4, and 5 can be included in ESI provided to the UE by the HPLMN.

These rankings help the UE decide which VPLMN to prioritize. The HPLMN can control the UE PLMN selection process operation as to whether the UE is to use ESI or SoR information for PLMN selection. For example, the HPLMN can use OTA signaling to configure the UE's SIM elementary file (EF) to expect to receive ESI. Additionally, the HPLMN can choose what information is included in the ESI that is sent to the UE via the SoR transparent container. In some embodiments, the UE can include a default configuration, such that if the UE is configured to expect to receive ESI from the HPLMN, and the HPLMN provides ESI, the UE will use the ESI for VPLMN selection prior to using the SoR information.

The UE can use the rankings provided in the ESI to select a VPLMN with which to register. The UE can select one among the requested S-NSSAI that is the highest preferred S-NSSAI. This is the slice that UE must find service on (essential slice). Other slices provided in the requested NSSAI if present can be ignored if not present in the VPLMN. For example, if the UE selects S-NSSAI-2 as the essential slice, then UE can only select PLMN-3 or PLMN-2 while S-NSSAI-2 is active (see, list 300 of FIG. 3). For example, enhanced mobile broadband (eMBB) can be an essential slice and other S-NSSAI(s) can be used to decide between PLMN-2 or PLMN-3 based on the highest rank. The UE can determine an essential slice. In particular, the UE can determine the applications currently executing on the UE. The UE can further determine the types of applications that are currently executing on the UE. Based on the application types, the UE can determine an essential slice. For example, the UE can determine that a user is executing a virtual reality application on the UE. The UE can determine that a network slice that supports virtual reality is an essential slice.

In some instances, the UE can further determine the number of slices supported by each VPLMN of s plurality of VPLMNs. As illustrated in FIG. 5, XXX-01 supports 3 slices, XXX-02 supports 3 slices, XXX-03 supports 4 slices, and XXX-04 supports 1 slice. The UE can further select the VPLMN based on the VPLMN supporting a largest number of network slices, wherein the largest number of network slices includes the essential slice. For example, if S-NSSAI-1 is the identifier for the essential slice, the UE can select XXX-03 as the VPLMN, as XXX-03 supports 4 network slices including the essential slice.

In some instances, the UE can determine any network slice that is not supported by a VPLMN that supports the essential slice, and disregard that slice. For example, consider a situation in which S-NSSAI-1 is the identifier for the essential slice. Further in this situation, there is no VPLMN that supports a network slice identified by S-NSSAI-1 and also a network slice identified by S-NSSAI-6. Therefore, the UE can disregard each instance of a network slice identified by S-NSSAI-6 when ranking different VPLMNs. For example, the UE can determine a rank of each VPLMN based on the prioritization information, wherein the rank of each VPLMN disregards any the network slice identified by S-NSSAI-6.

In some instances, the HPLMN can transmit Network Slice Simultaneous Registration Group (NSSRG) information to the UE. (3GPP TS 24.501. V0.0.0 (2017-10). The NSSRG can convey information to UE indicating the S-NSSAIs that belonging to the same group and that can be activated simultaneously. NSSRG information can be used by the UE to decide which S-NSSAIs can be activated (e.g., only those S-NSSAIs belonging to the same group), and accordingly the ranking of the VPLMNs can be decided based on the NSSRG. For example, if both S-NSSAI-1 and S-NSSAI-2 belong to group A, and S-NSSAI3 belongs to group B, then the UE can either activate at a time only S-NSSAI-1 & S-NSSAI-2 or only S-NSSAI-3. If UE is trying to activate S-NSSAI-2 and S-NSSAI-3, each to a different slice group, then the UE can decide which to activate based on the application(s) executing on the UE and the priority information (essential slice). For example, if S-NSSAI-3 is a priority (or essential slice) then the UE can prefer to select those VPLMNs which support S-NSSAI-3. The UE can then further prioritize the VPLMNs that support S-NSSAI-3 based on a ranking table (e.g., one or more of FIGS. 3-5).

The ESI can indicate the same rank assigned to different PLMNs that supported the same slice. This can help reduce ping-pongs between PLMNs based on the slices being activated.

The UE can consider the largest set of S-NSSAIs (containing the highest priority slice that is active) that can be served by a PLMN to select a VPLMN. In some instances, the ESI list can indicate that two or more PLMNs can provide service for the same slice combination (e.g., S-NSSAI-1 and S-NSSAI-2). In these instances, the UE can camp on any of the two or more PLMNs, if the sum of the rankings of the S-NSSAIs is same. For example, S-NSSAI-1 and S-NSSAI-2 have same ranking sum of 4 for both PLMN 2 (2+2) and PLMN 3 (3+1) (see list 500 of FIG. 5).

The configured slice priority can help UE in selecting the slice with the highest priority along with the set of slices that can be supported on the determined highest priority PLMN. For example, the UE selects S-NSSAI-1 as the highest preferred slice. The UE then chooses to activate both S-NSSAI-1 and S-NSSAI-5. In this example, the UE can select PLMN 1 instead of PLMN 4, as PLMN-1 serves S-NSSAI-1 and PLMN-4 only serves S-NSSAI-5 which is the lowest preferred slice.

If the UE receives rejected network slice specific authentication and authorization (NSSAA) for any of the requested S-NSSAIs, then based on the cause of the rejection, the UE can either continue seeking the same S-NSSAI or discontinue seeking the same S-NSSAI. For example, if the NSSAA has failed for an S-NSSAI, then UE will no longer consider the same S-NSSAI for evaluation of the PLMN rank (until there is a request from UE's AP to re-activate the slice). In another example, if S-NSSAI-1 and S-NSSAI-2 are in the requested NSSAI and S-NSSAI-1 fails the NSSAA process, then only S-NSSAI-2 is considered for PLMN selection. In this example, PLMN 3 is the highest preferred PLMN for the UE.

The UE can be configured with various triggers for starting a higher priority PLMN timer using ESI. One trigger can be that a packet data unit (PDU) session is released and the S-NSSAI corresponding to the PDU session has no other PDU session pending. Another trigger can be that the S-NSSAI is no longer active in the UE, as either locally deactivated (or released) or the S-NSSAI is no longer present in the Allowed NSSAI (Allowed NSSAI can be updated by network using REGISTRATION ACCEPT message/CONFIGURATION UPDATE COMMAND message). Yet another trigger can be that the S-NSSAI is requested by UE in the REGISTRATION REQUEST message, but network sends the same S-NSSAI in the rejected NSSAI along with the registration reject cause that “S-NSSAI not available in the current PLMN or standalone non-public network (SNPN)” or “S-NSSAI not available due to the failed or revoked network slice-specific authentication and authorization.”

If the UE receives a TA-specific registration reject causes (3GPP TS 24.501 V18.3.1 (2023-06)), the UE continues to consider the S-NSSAI as active. For example, if the UE receives the registration reject cause “S-NSSAI not available in the current registration area” or “S-NSSAI not available due to maximum number of UEs reached”, the UE continues to consider the S-NSSAI as active. If UE receives reject cause #62—“No network slices available”, then the UE will send “UE assistance information” IE in UL NAS TRANSPORT message to be passed to HPLMN via a transparent container by the PLMN (e.g., VPLMN) on which the UE is camped. Upon receipt of the message, the HPLMN can then provide the ESI, including the PLMN list to the UE. The UE can consider the PLMNs on the list, and based on this information, the UE can decide if it needs to stay camped on the same PLMN or select another PLMN that can provide the requested slices or a subset of the requested slices.

The UE can start a search for a higher priority PLMN immediately when UE has the ESI and the UE's AP has requested to activate a S-NSSAI that is not active in Allowed NSSAI.

The UE can further be triggered to use ESI to search for a higher priority VPLMN when the UE is camped on long term evolution (LTE) radio access technology (RAT). For example, if the UE camps on LTE RAT of a prioritized PLMN based on ESI handling, then the UE must consider the S-NSSAIs that are active (based on the active packet data network (PDN) sessions on LTE) to determine if the UE needs to select to a higher priority PLMN or not, based on the ESI. If the UE determines that the UE needs to select a higher priority PLMN, the UE will start the high priority PLMN search timer.

If either the UE or the network deactivates any PDN session in LTE then the corresponding S-NSSAI (if no other PDN session containing the S-NSSAI is active) is considered as deactivated, and the UE can start the high priority PLMN search timer and search for higher priority PLMNs (if any) based on the ESI.

In some instances, the UE can use the list included in the ESI to camp on a determined PLMN as the highest priority PLMN when the UE is recovering service from “Out Of Service” or camped in limited service mode.

In some instances, a user use a manual mode selection manually select a VPLMN. This can occur when the list included the ESI is available at the UE (e.g., for a user to browse) and the UE has previously used the list included in the ESI to select a suitable PLMN. When a user selected PLMN is providing service then UE remains on the same user selected PLMN even when higher preferred PLMNs are available as per Slice based SoR PLMN selection list using active S-NSSAIs (3GPP TS 23.122 V18.3.0 (2023-06)). If the UE loses coverage of the user selected PLMN, then the UE can display a pop-up indicating that higher preferred PLMN(s) being available based on active S-NSSAIs. The user can, based on the information further enter a manual input to exit the manual selection mode on the UE and enter automatic selection mode. In the automatic selection mode, UE can determine a higher preferred PLMN based on any active S-NSSAIs and camp on the determined higher preferred PLMN.

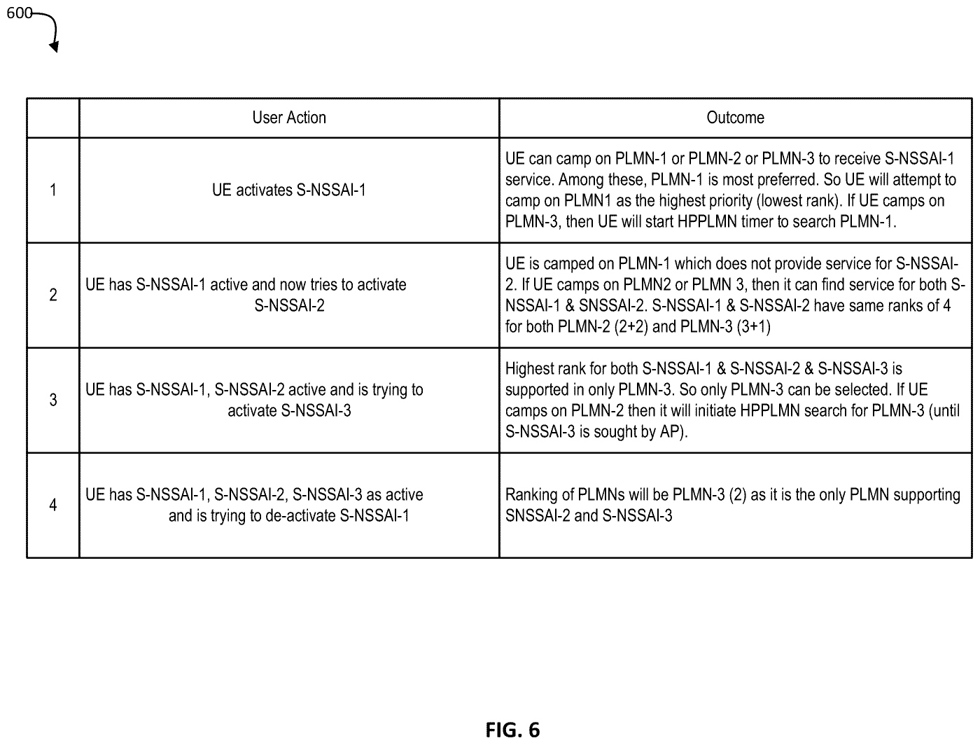

FIG. 6 is a table 600 of use cases for slice-based PLMN selection, according to one or more embodiments. The following use cases rely on the PLMNs, S-NSSAIs, and rankings as described in FIGS. 3 and 5. It should be appreciated that in a different scenario, different PLMNs can support different S-NSSAIs, and the ranking can be different. For a first use case, the UE can activate S-NSSAI-1. In this use case, UE can camp on PLMN 1 or PLMN 2 or PLMN 3 to receive S-NSSAI-1 service. Among these, PLMN 1 is most preferred (see, FIG. 5). Therefore, the UE will attempt to camp on PLMN 1 as the highest priority (lowest rank). If the UE camps on PLMN 3 in which S-NSSAI is the third highest ranked slice (see, FIGS. 3 and 5), then UE will start a highest priority (HP) PLMN timer to search for a higher priority PLMN (e.g., PLMN 1).

In a second use case, UE can have S-NSSAI-1 active and then activate S-NSSAI-2. In this use case, the UE can be camped on PLMN-1 which does not provide service for S-NSSAI-2 (see, FIG. 5). If the UE camps on PLMN 2 or PLMN 3, then the UE can find service for both S-NSSAI-1 and SNSSAI-2. S-NSSAI-1 and S-NSSAI-2 have the same combined rank value of 4 for both PLMN 2 (2+2) and PLMN 3 (3+1) (see, FIG. 5).

In a third use case, the UE has UE has S-NSSAI-1, S-NSSAI-2 active and is trying to activate S-NSSAI-3. In this use case, the highest rank for both S-NSSAI-1 & S-NSSAI-2 & S-NSSAI-3 is supported in only PLMN 3 (see, FIG. 5). Therefore, only PLMN 3 can be selected. If the UE camps on PLMN 2, then it will initiate a PLMN search for a higher priority PLMN (e.g., PLMN 3), until S-NSSAI-3 is sought by the UE's AP.

In a fourth use case, the UE has S-NSSAI-1, S-NSSAI-2, S-NSSAI-3 as active and is trying to deactivate S-NSSAI-1. The ranking of PLMNs will only include PLMN-3 (2) as it is the only PLMN supporting SNSSAI-2 and S-NSSAI-3 (see, FIG. 5).

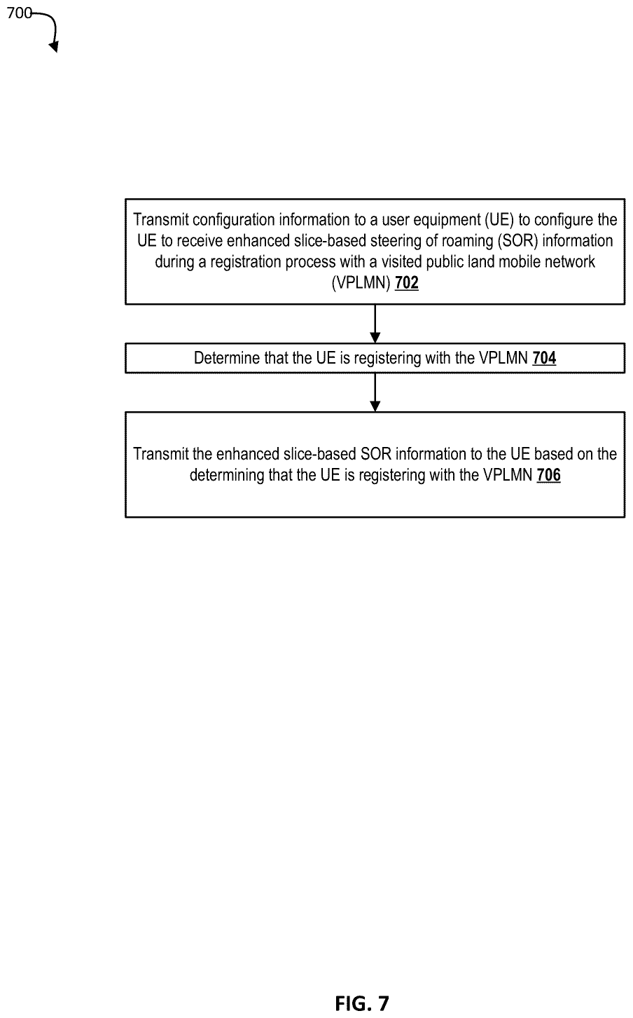

FIG. 7 is a process flow 700 for slice-based PLMN selection, according to one or more embodiments. At 702, the method can include a network node of an HPLMN transmitting configuration information to a user equipment (UE) to configure the UE to receive enhanced slice-based SoR information (ESI) during a registration process with a visited public land mobile network (VPLMN).

At 704, the method can include the network node determining that the UE is registering with the VPLMN.

At 706, the method can include the network node transmitting the enhanced slice-based SOR information to the UE based on determining that the UE is registering with the VPLMN.

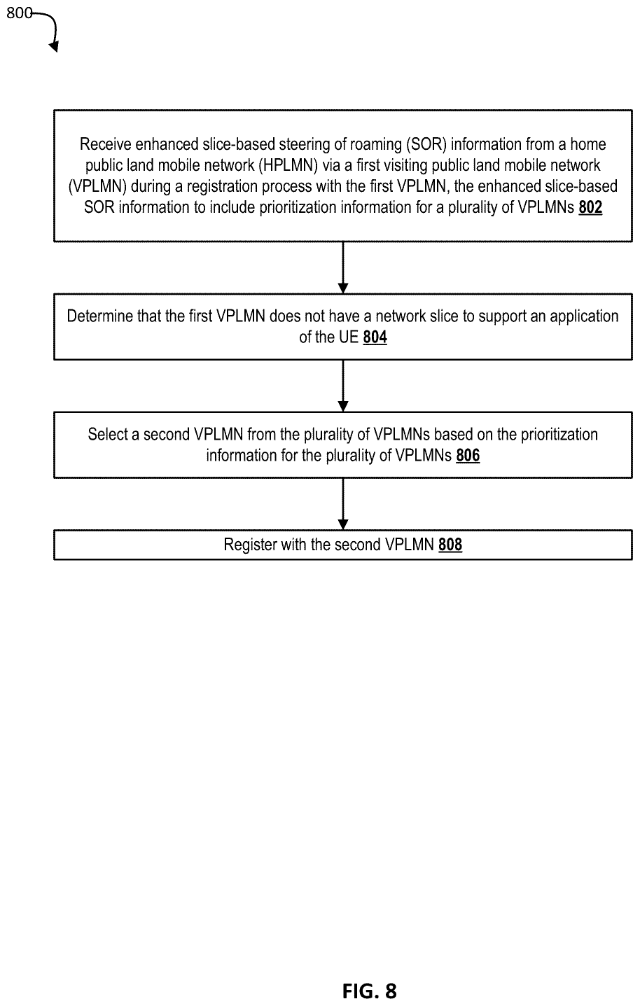

FIG. 8 is a process flow 800 for slice-based PLMN selection, according to one or more embodiments. At 802, the method can include a UE receiving, via a UE interface, enhanced slice-based SoR information (ESI) from an HPLMN, via a first visiting public land mobile network (VPLMN) during a registration process with the first VPLMN, the enhanced slice-based SoR information to include prioritization information for a plurality of VPLMNs.

At 804, the method can include the UE determining that the first VPLMN does not have a network slice to support an application of the UE.

At 806, the method can include the UE selecting a second VPLMN from the plurality of VPLMNs based on the prioritization information for the plurality of VPLMNs.

At 808, the method can include the UE registering with the second VPLMN.

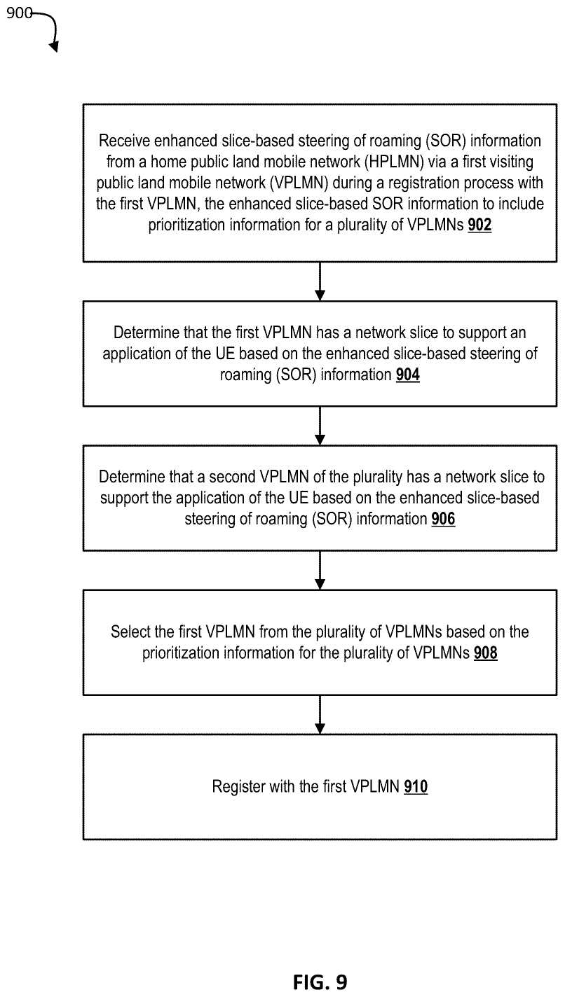

FIG. 9 is a process flow 900 for slice-based PLMN selection, according to one or more embodiments. At 902, the method can include a UE receiving, via a UE interface, enhanced slice-based SoR information (ESI) from a home public land mobile network (HPLMN) via a first visiting public land mobile network (VPLMN) during a registration process with the first VPLMN, the enhanced slice-based SoR information to include prioritization information for a plurality of VPLMNs.

At 904, the method can include the UE determining that the first VPLMN has a network slice to support an application of the UE based on the enhanced slice-based SoR information.

At 906, the method can include the UE determining that a second VPLMN of the plurality has a network slice to support the application of the UE based on the enhanced slice-based SoR information.

At 908, the method can include the UE comparing a slice-based ranking of the first VPLMN to a slice-based ranking of the second VPLMN based on the prioritization information for the plurality of VPLMNs.

At 910, the method can include the UE selecting the first VPLMN from the plurality of VPLMNs based on the prioritization information for the plurality of VPLMNs.

At 912, the method can include the UE registering with the first VPLMN.

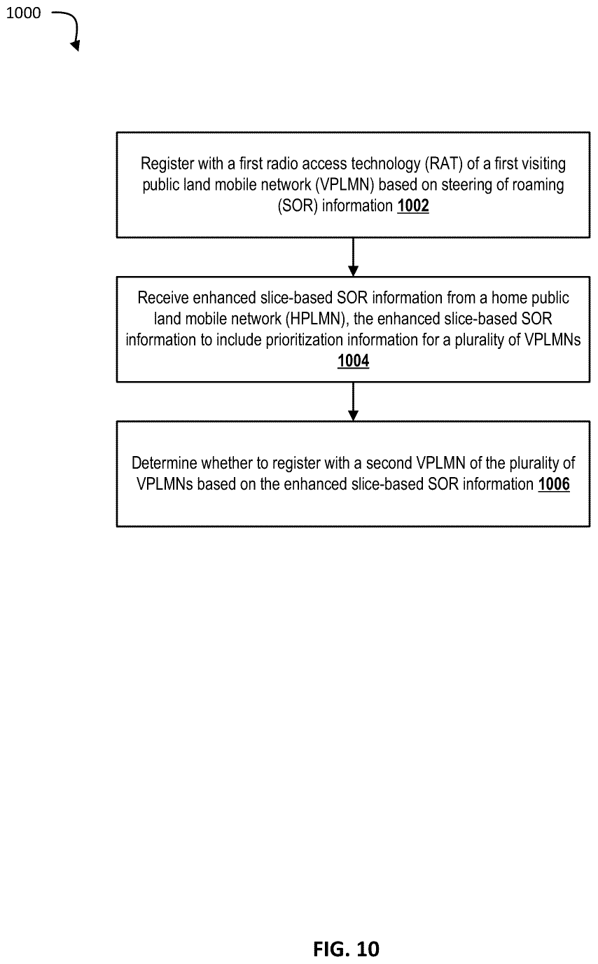

FIG. 10 is a process flow 1000 for slice-based PLMN selection, according to one or more embodiments. At 1002, the method can include the UE registering with a first radio access technology (RAT) of a first VPLMN based on SoR information.

At 1004, the method can include the UE receiving enhanced slice-based SOR information from an (HPLMN, the enhanced slice-based SoR information to include prioritization information for a plurality of VPLMNs.

At 1006, the method can include the UE determining whether to register with a second VPLMN of the plurality of VPLMNs based on the enhanced slice-based SOR information.

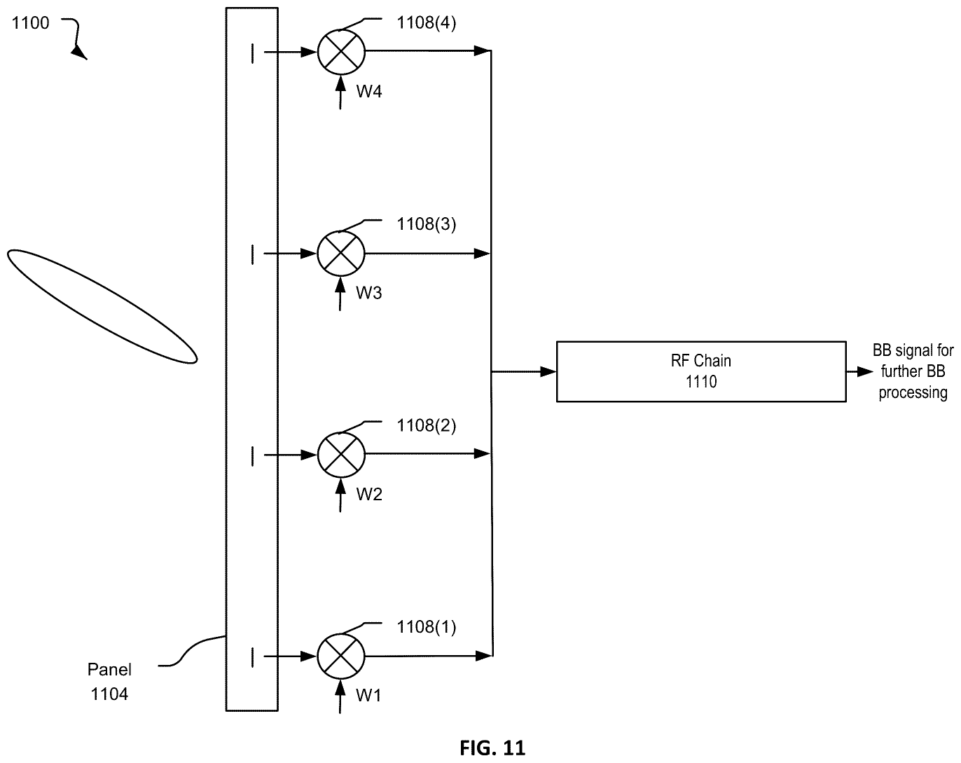

FIG. 11 illustrates receive components 1100 of the UE 1106, in accordance with some embodiments. The receive components 1100 may include an antenna panel 1104 that includes a number of antenna elements. The panel 1104 is shown with four antenna elements, but other embodiments may include other numbers.

The antenna panel 1104 may be coupled to analog beamforming (BF) components that include a number of phase shifters 1108(1)-1108(4). The phase shifters 1108(1)-1108(4) may be coupled with a radio-frequency (RF) chain 1112. The RF chain 1112 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (e.g., W1-W4), which may represent phase shift values, to the phase shifters 1108(1)-1108(4) to provide a receive beam at the antenna panel 1104. These BF weights may be determined based on the channel-based beamforming.

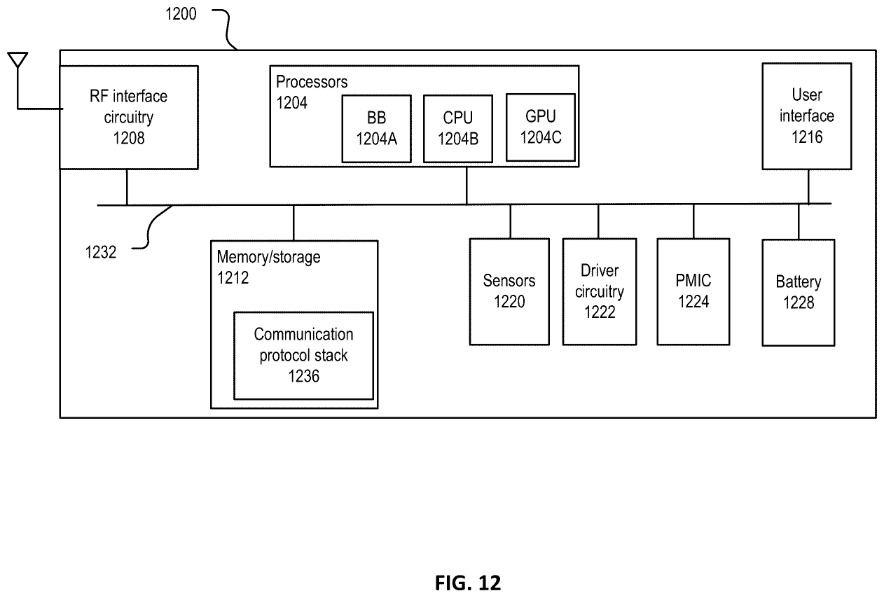

FIG. 12 illustrates a UE 1200, in accordance with some embodiments. The UE 1200 may be similar to and substantially interchangeable with UE 1106 of FIG. 11.

Similar to that described above with respect to UE 1200, the UE 1200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1200 may include processors 1204, RF interface circuitry 1208, memory/storage 1212, user interface 1216, sensors 1220, driver circuitry 1222, power management integrated circuit (PMIC) 1224, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangements of the components shown may occur in other implementations.

The components of the UE 1200 may be coupled with various other components over one or more interconnects 1232, which may represent any type of interface, input/output, bus (local, system, or expansion), transmission line, trace, optical connection, etc. that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the UE 1200 to perform operations as described herein.

In some embodiments, the baseband processor circuitry 1204A may access a communication protocol stack 1236 in the memory/storage 1212 to communicate over a 3GPP compatible network. In general, the baseband processor circuitry 1204A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1212 may include any type of volatile or non-volatile memory that may be distributed throughout the UE 1200. In some embodiments, some of the memory/storage 1212 may be located on the processors 1204 themselves (for example, L1 and L2 cache), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1208 may include transceiver circuitry and a radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1224 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1224.

In various embodiments, the RF interface circuitry 1208 may be configured to transmit/receive signals in a manner compatible with NR access technologies.

The antenna 1224 may include a number of antenna elements that each convert electrical signals into radio waves to travel through the air and to convert received radio waves into electrical signals. The antenna elements may be arranged into one or more antenna panels. The antenna 1224 may have antenna panels that are omnidirectional, directional, or a combination thereof to enable beamforming and multiple input, multiple output communications. The antenna 1224 may include microstrip antennas, printed antennas fabricated on the surface of one or more printed circuit boards, patch antennas, phased array antennas, etc. The antenna 1224 may have one or more panels designed for specific frequency bands including bands in FR1 or FR2.

The user interface circuitry 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1200.

The sensors 1220 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various input/output (I/O) devices that may be present within, or connected to, the UE 1200. For example, driver circuitry 1222 may include a display driver to control and allow access to a display device, a touchscreen driver to control and allow access to a touchscreen interface, sensor drivers to obtain sensor readings of sensor circuitry 1220 and control and allow access to sensor circuitry 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

In some embodiments, the PMIC 1224 may control, or otherwise be part of, various power saving mechanisms of the UE 1200. For example, if the platform UE is in an RRC_Connected state, where it is still connected to the radio access network (RAN) node as it expects to receive traffic shortly, then it may enter a state known as Discontinuous Reception Mode (DRX) after a period of inactivity. During this state, the UE 1200 may power down for brief intervals of times and thus save power. If there is no data traffic activity for an extended period of time, then the UE 1200 may transition off to an RRC_Idle state, where it disconnects from the network and does not perform operations such as channel quality feedback, handover, etc. The UE 1200 goes into a very low power state and it performs paging where again it periodically wakes up to listen to the network and then powers down again. The UE 1200 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1228 may power the UE 1200, although in some examples the UE 1200 may be mounted deployed in a fixed location, and may have a power supply coupled to an electrical grid. The battery 1228 may be a lithium ion battery, a metal-air battery, such as a zinc-air battery, an aluminum-air battery, a lithium-air battery, and the like. In some implementations, such as in vehicle-based applications, the battery 1228 may be a typical lead-acid automotive battery.

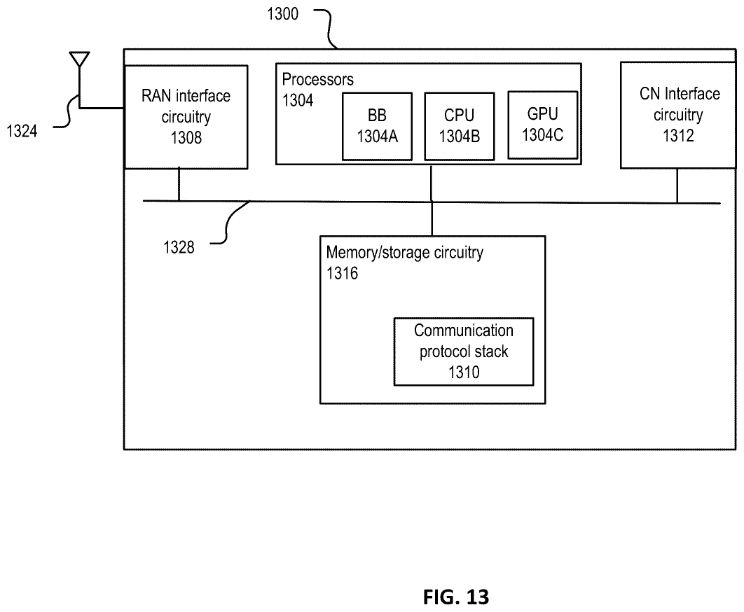

FIG. 13 illustrates a network node 1300, in accordance with some embodiments. The network node 1300 may include processors 1304, RF interface circuitry 1308, core network (CN) interface circuitry 1312, and memory/storage circuitry 1316. The network node 1300 can be a node of a RAN or a CN.

The components of the network node 1300 may be coupled with various other components over one or more interconnects 1328.

The processors 1304, RF interface circuitry 1308, memory/storage circuitry 1316 (including communication protocol stack 1310), antenna 1324, and interconnects 1328 may be similar to like-named elements shown and described with respect to FIG. 11.

The CN interface circuitry 1312 may provide connectivity to a CN, for example, a 4th Generation Core network (5GC) using a 4GC-compatible network interface protocol such as carrier Ethernet protocols, or some other suitable protocol. Network connectivity may be provided to/from the network node 1300 via a fiber optic or wireless backhaul. The CN interface circuitry 1312 may include one or more dedicated processors or FPGAs to communicate using one or more of the aforementioned protocols. In some implementations, the CN interface circuitry 1312 may include multiple controllers to provide connectivity to other networks using the same or different protocols.

As indicated above, in other embodiments, the network node 1300 can be a CN node. In these embodiments, the include RF interface circuitry 1308 for connectivity with a RAN. The RF interface circuitry 1308 may include one or more dedicated processors or FPGAs to communicate using one or more of the aforementioned protocols. In some implementations, the RF interface circuitry 1308 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further example embodiments are provided.

Example 1 includes a network node of a home public land mobile network (HPLMN), comprising: processing circuitry; and one or more computer-readable media including instructions that, when executed by the processing circuitry, cause the HPLMN to perform operations comprising: transmitting configuration information to a user equipment (UE) to configure the UE to receive enhanced slice-based steering of roaming (SoR) information during a registration process with a visited public land mobile network (VPLMN); determining that the UE is registering with the VPLMN; and transmitting the enhanced slice-based SoR information to the UE based on the determination that the UE is registering with the VPLMN.

Example 2 includes the network node of the HPLMN of example 1, wherein configuring UE to receive the enhanced slice-based SoR information comprises configuring a universal subscriber identity module (USIM) of the UE to expect the enhanced slice-based SoR information during a registration process with the VPLMN.

Example 3 includes the network node of the HPLMN of any of examples 1 and 2, wherein the operations further comprise: transmitting enhanced slice-based SoR information to the UE via the VPLMN.

Example 4 includes the network node of the HPLMN of any of examples 1-3, wherein the operations further comprise: determining that first information has been updated, the first information to include the enhanced slice-based SoR information, the SoR information, or both; and transmitting a first message including the first information to the UE.

Example 5 includes the network node of the HPLMN of example 4, wherein the operations further comprise: transmitting a second message to the UE to indicate that second information has not been updated, the second information to include whichever of the enhanced slice-based SoR information or the SoR information that is not included in the first information.

Example 6 includes the network node of the HPLMN of any of examples 1-5, wherein the operations further comprise: determining that neither the enhanced slice-based SoR information nor the SoR information has been updated; and transmitting a message to the UE to indicate that neither the enhanced slice-based SoR information nor the SoR information has been updated.

Example 7 includes the network node of the HPLMN of any of examples 1-6, wherein the operations further comprise: determining a location of the UE based on determining that the UE is registering with the VPLMN; determining available slices in the location of the UE; receiving assistance information from the UE via the VPLMN; generating the enhanced slice-based SoR information based on the available slices and the assistance information.

Example 8 includes the network node of the HPLMN of any of examples 1-7, wherein the operations further comprise: generating the enhanced slice-based SoR information comprising: a VPLMN ranking list to rank a plurality of VPLMNs, including the VPLMN, based on slices available in respective VPLMNs of the plurality of VPLMNs and the slices available in respective VPLMNs, based on business relationship of the VPLMN with HPLMN, and transmitting the VPLMN ranking list to the UE.

Example 9 includes a method for performing any of the steps of examples 1-8.

Example 10 includes a computer-readable medium having stored thereon a sequence of instructions which, when executed, causes a processor to perform operations including a method described in or related to examples 1-8.

Example 11 includes an apparatus comprising memory to store enhanced slice-based steering of roaming (SoR) information; and processing circuitry coupled with the memory, the processing circuitry to perform any of the steps of examples 1-8.

Example 12 includes a user equipment (UE), comprising: an interface; and processing circuitry, coupled with the interface, the processing circuitry to: receive, via the interface, enhanced slice-based steering of roaming (SoR) information from a home public land mobile network (HPLMN) via a first visiting public land mobile network (VPLMN) during a registration process with a first VPLMN, the enhanced slice-based SoR information to include prioritization information for a plurality of VPLMNs; determine that the first VPLMN does not have a network slice to support an application of the UE; select a second VPLMN from the plurality of VPLMNs based on the prioritization information for the plurality of VPLMNs; and register with the second VPLMN.

Example 13 includes the UE of example 12, wherein the processing circuitry is further to: transmit assistance information to the HPLMN, wherein the assistance information includes a list of preferred single—network slice selection assistance informations (S-NSSAIs).

Example 14 includes the UE of example 13, wherein the processing circuitry is further to: receive an acknowledgment to indicate that a unified data management (UDM) of the HPLMN has received the list of preferred S-NSSAIs.

Example 15 includes the UE example 13, wherein the processing circuitry is further to: receive a request from the HPLMN for the assistance information, wherein the UE transmits the list of preferred S-NSSAIs based on the request from the HPLMN.

Example 16 includes the UE of any of examples 12-15, wherein the second VPLMN has a first plurality of S-NSSAIs and a third VPLMN of the plurality of VPLMNs has a second plurality of S-NSSAIs, wherein the processing circuitry is further to: compare a slice-based ranking of the second VPLMN to a slice-based ranking of the third VPLMN based on the prioritization information for the plurality of VPLMNs; and select the second VPLMN from the plurality of VPLMNs based at least in part on the comparison.

Example 17 includes the UE of any of examples 12-16, wherein selecting the second VPLMN from the plurality of VPLMNs based on the prioritization information for the plurality of VPLMNs comprises: determining an essential slice; determining a number of slices supported by each VPLMN of the plurality of VPLMNs; and selecting the second VPLMN from the plurality of VPLMNs based on the second VPLMN supporting a largest number of network slices, wherein the largest number of network slices includes the essential slice.

Example 18 includes the UE of any of examples 12-17, wherein selecting the second VPLMN from the plurality of VPLMNs based on the prioritization information for the plurality of VPLMNs comprises: determining an essential slice; determining any network slice that is not supported by a VPLMN of the plurality of VPLMNs that supports the essential slice; determining a rank of each VPLMN of the plurality of VPLMNs based on the based on the prioritization information, wherein the rank of each VPLMN disregards any network slice that is not supported by a VPLMN of the plurality of VPLMNs that supports the essential slice; and selecting the second VPLMN from the plurality of VPLMNs based on a rank of the second VPLMN.

Example 19 includes the UE of example 18, wherein determining the essential slice comprises: determining respective type of each application executing on the UE; and selecting the essential slice based on the respective type of each application executing on the UE.

Example 20 includes the UE of any of examples 12-19, wherein selecting the second VPLMN from the plurality of VPLMNs based on the prioritization information for the plurality of VPLMNs comprises: determining an essential slice; receiving Network Slice Simultaneous Registration Group (NSSRG) information from an HPLMN; determining that the essential slice belongs a first group of network slices of a plurality of groups of network slices based on the NSSRG information; determining each VPLMN of the plurality of VPLMNs that supports the first group of network slices; and selecting the second VPLMN based on the determination and the prioritization information, wherein the second VPLMN supports the first group of network slices.

Example 21 includes the UE of any of examples 12-20, wherein selecting the second VPLMN from the plurality of VPLMNs based on the prioritization information for the plurality of VPLMNs comprises: selecting a subset of VPLMNs from the plurality of VPLMNs, the subset of VPLMNs including the second VPLMN; determining a highest priority VPLMN of the subset of VPLMNs based on the prioritization information for the plurality of VPLMNs; and selecting the second VPLMN based on the second VPLMN being the highest priority VPLMN from the subset of VPLMNs.

Example 22 includes the UE of example 21, wherein the UE selects the subset of VPLMNs based on implementation choice, local configuration, or user input.

Example 23 includes the UE of any of examples 12-22, wherein the processing circuitry is further to: determine to activate a first network slice and a second network slice, wherein the first network slice has a higher preference score than the second network slice; determine that the second VPLMN supports the first network slice and a third VPLMN supports the second network slice; and select the second VPLMN over the third VPLMN based on determining the first network slice has a higher preference score than the second network slice.

Example 24 includes the UE of any of examples 12-23, wherein the processing circuitry is further to: detect a trigger to determine whether to register with the second VPLMN; start a PPLMN search timer; and determine whether to register with the second VPLMN prior to expiration of the timer.

Example 25 includes the UE of example 23, wherein the trigger comprises: a current PDU session is released and a current network slice has no other PDU session pending; the network slice is no longer active with respect to the UE; or the first VPLMN transmitting a message to indicate that the first VPLMN does have the network slice to support the application.

Example 26 includes a method for performing any of the steps of examples 12-25.

Example 27 includes a computer-readable medium having stored thereon a sequence of instructions which, when executed, causes a processor to perform operations including a method described in or related to examples 12-25.

Example 28 includes an apparatus comprising memory to store enhanced slice-based steering of roaming (SoR) information; and processing circuitry coupled with the memory, the processing circuitry to perform any of the steps of examples 12-26.

Example 29 includes a UE, comprising: an interface; and processing circuitry, coupled with the interface, the processing circuitry to: receive, via the interface, enhanced slice-based SoR information from a HPLMN via a first visiting public land mobile network (VPLMN) during a registration process with a first VPLMN, the enhanced slice-based SoR information to include prioritization information for a plurality of VPLMNs; determine that the first VPLMN has a network slice to support an application of the UE based on the enhanced slice-based SoR information; determine that a second VPLMN of the plurality has a network slice to support the application of the UE based on the enhanced slice-based SoR)information; compare a slice-based ranking of the first VPLMN to a slice-based ranking of the second VPLMN based on the prioritization information for the plurality of VPLMNs; select the first VPLMN from the plurality of VPLMNs based on the prioritization information for the plurality of VPLMNs and a higher ranking of the first VPLMN; and register with the first VPLMN.

Example 30 includes a method for performing example 29.

Example 31 includes a computer-readable medium having stored thereon a sequence of instructions which, when executed, causes a processor to perform operations including a method described in or related to example 29.

Example 32 includes an apparatus comprising memory to store enhanced slice-based steering of roaming (SoR) information; and processing circuitry coupled with the memory, the processing circuitry to perform any of the steps of example 29.

Example 33 one or more computer-readable media having stored thereon a sequence of instructions which, when executed by one or more processors, cause a UE to: register with a first RAT of a first VPLMN based on SoR information; receive enhanced slice-based SoR information from a (HPLMN, the enhanced slice-based SoR information to include prioritization information for a plurality of VPLMNs; and determine whether to register with a second VPLMN of the plurality of VPLMNs based on the enhanced slice-based SoR information.

Example 34 includes the one or more computer-readable media of example 33, wherein the instructions which, when executed by one or more processors, further cause the UE to: detect a trigger to perform a search for a higher priority PLMN; start a PLMN search timer based on the detecting the trigger; and determine whether to register with a second PLMN prior to expiration of the PLMN search timer.

Example 35 includes the one or more computer-readable media of example 34, wherein the instructions which, when executed by one or more processors, further cause the UE to: compare slice-based rankings of the plurality of VPLMNs based on the prioritization information for a plurality of VPLMNs based on detecting the trigger; and determine whether to register with a second VPLMN based on the rankings.

Example 36 includes the one or more computer-readable media of any of examples 34 and 35, wherein the instructions which, when executed by one or more processors, further cause the UE to: present, via a display of the UE, prioritization information for a plurality of VPLMNs including a ranking each VPLMN of the plurality of VPLMNs; receive a user-based manual input to register with the second VPLMN; and register with the second VPLMN based on the user-based manual input.

Example 37 includes a method for performing any of the steps of examples 30-32.

Example 38 includes a UE for performing any of the steps of examples 30-32.

Example 39 includes an apparatus comprising memory to store enhanced slice-based steering of roaming (SoR) information; and processing circuitry coupled with the memory, the processing circuitry to perform any of the steps of example 29.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
transmitting configuration information to a user equipment (UE) to configure the UE to receive enhanced slice-based steering of roaming (SoR) information during a registration process with a visited public land mobile network (VPLMN);
determining that the UE is registering with the VPLMN; and
transmitting the enhanced slice-based SoR information to the UE based on the determination that the UE is registering with the VPLMN.

2. The method of claim 1, wherein configuring UE to receive the enhanced slice-based SoR information comprises configuring a universal subscriber identity module (USIM) of the UE to expect the enhanced slice-based SoR information during a registration process with the VPLMN.

3. The method of claim 1, further comprising:
transmitting enhanced slice-based SoR information to the UE via the VPLMN.

4. The method of claim 1, further comprising:
determining that first information has been updated, the first information to include the enhanced slice-based SoR information, SoR information, or both; and
transmitting a first message including the first information to the UE.

5. The method of claim 4, further comprising:
transmitting a second message to the UE to indicate that second information has not been updated, the second information to include whichever of the enhanced slice-based SoR information or the SoR information that is not included in the first information.

6. The method of claim 1, further comprising:
determining that neither the enhanced slice-based SoR information nor SoR information has been updated; and
transmitting a message to the UE to indicate that neither the enhanced slice-based SoR information nor the SoR information has been updated.

7. The method of claim 1, further comprising:
determining a location of the UE based on determining that the UE is registering with the VPLMN;
determining available slices in the location of the UE;
receiving assistance information from the UE via the VPLMN;
generating the enhanced slice-based SoR information based on the available slices and the assistance information.

8. The method of claim 1, further comprising:
generating the enhanced slice-based SoR information comprising:
a VPLMN ranking list to rank a plurality of VPLMNs, including the VPLMN, based on slices available in respective VPLMNs of the plurality of VPLMNs and slices available in respective VPLMNs, based on business relationship of the VPLMN with HPLMN, and transmitting the VPLMN ranking list to the UE.

9. An apparatus comprising:
memory to store enhanced slice-based steering of roaming (SoR) information; and
processing circuitry coupled with the memory, the processing circuitry to:
receive the enhanced slice-based SoR information from a home public land mobile network (HPLMN) via a first visiting public land mobile network (VPLMN) during a registration process with a first VPLMN, the enhanced slice-based SoR information to include prioritization information for a plurality of VPLMNs;
determine that the first VPLMN does not have a network slice to support an application of a user equipment (UE);
select a second VPLMN from the plurality of VPLMNs based on the prioritization information for the plurality of VPLMNs; and
register with the second VPLMN.

10. The apparatus of claim 9, wherein the processing circuitry is further to:
transmit assistance information to the HPLMN, wherein the assistance information includes a list of preferred single—network slice selection assistance informations (S-NSSAIs).

11. The apparatus of claim 10, wherein the processing circuitry is further to:
receive an acknowledgment to indicate that a unified data management (UDM) of the HPLMN has received the list of preferred S-NSSAIs.

12. The apparatus of claim 10, wherein the processing circuitry is further to:
receive a request from the HPLMN for the assistance information, wherein the UE transmits the list of preferred S-NSSAIs based on the request from the HPLMN.

13. The apparatus of claim 9, wherein the second VPLMN has a first plurality of S-NSSAIs and a third VPLMN of the plurality of VPLMNs has a second plurality of S-NSSAIs, wherein the processing circuitry is further to:
compare a slice-based ranking of the second VPLMN to a slice-based ranking of the third VPLMN based on the prioritization information for the plurality of VPLMNs; and
select the second VPLMN from the plurality of VPLMNs based at least in part on the comparison.

14. The apparatus of claim 9, wherein selecting the second VPLMN from the plurality of VPLMNs based on the prioritization information for the plurality of VPLMNs comprises:
determining an essential slice;
determining a number of slices supported by each VPLMN of the plurality of VPLMNs; and
selecting the second VPLMN from the plurality of VPLMNs based on the second VPLMN supporting a largest number of network slices, wherein the largest number of network slices includes the essential slice.

15. The apparatus of claim 9, wherein selecting the second VPLMN from the plurality of VPLMNs based on the prioritization information for the plurality of VPLMNs comprises:
determining an essential slice;
determining any network slice that is not supported by a VPLMN of the plurality of VPLMNs that supports the essential slice;
determining a rank of each VPLMN of the plurality of VPLMNs based on the prioritization information, wherein the rank of each VPLMN disregards any network slice that is not supported by a VPLMN of the plurality of VPLMNs that supports the essential slice; and
selecting the second VPLMN from the plurality of VPLMNs based on a rank of the second VPLMN.

16. The apparatus of claim 14, wherein determining the essential slice comprises:
determining respective type of each application executing on the UE; and
selecting the essential slice based on the respective type of each application executing on the UE.

17. One or more computer-readable media having stored thereon a sequence of instructions which, when executed, cause processing circuitry to:
register with a first radio access technology (RAT) of a first visiting public land mobile network (VPLMN) based on steering of roaming (SoR) information;
receive enhanced slice-based SoR information from a home public land mobile network (HPLMN), the enhanced slice-based SoR information to include prioritization information for a plurality of VPLMNs; and
determine whether to register with a second VPLMN of the plurality of VPLMNs based on the enhanced slice-based SoR information.

18. The one or more computer-readable media of claim 17, wherein the instructions which, when executed by one or more processors, further cause the processing circuitry to:
detect a trigger to perform a search for a higher priority PLMN;
start a PLMN search timer based on detecting the trigger; and
determine whether to register with a second PLMN prior to expiration of the PLMN search timer.

19. The one or more computer-readable media of claim 17, wherein the instructions which, when executed by one or more processors, further cause the processing circuitry to:
compare slice-based rankings of the plurality of VPLMNs based on the prioritization information for a plurality of VPLMNs based on detecting a trigger; and
determine whether to register with a second VPLMN based on the slice-based rankings.

20. The one or more computer-readable media of claim 17, wherein the instructions which, when executed by one or more processors, further cause the processing circuitry to:
present, via a display of the UE, prioritization information for a plurality of VPLMNs including a ranking each VPLMN of the plurality of VPLMNs;
receive a user-based manual input to register with the second VPLMN; and
register with the second VPLMN based on the user-based manual input.
